(19) United States
(12) Patent Application Publication
(10) Pub. No.: US 2026/0044298 A1
(43) Pub. Date: Feb. 12, 2026

(54) MANAGING DEVICE VISUAL PROJECTION ON A CONNECTED DISPLAY

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN)

(21) Appl. No.: 18/800,389

(22) Filed: Aug. 12, 2024

(51) Int. Cl. G06F 3/14

(52) U.S. Cl. CPC G06F 3/1454

(57) ABSTRACT

An electronic device, computer program product, and method provide autonomous projection of a selected viewable content to a second display. The device is configured to, in response to receiving a trigger to project selected viewable content to a selected second display: determine, by evaluating location information of the electronic device and location information of the selected second display, whether the selected second display is located within an acceptable range of and in a line-of-sight of a user of the electronic device; and in response to confirming that the second electronic device is within the acceptable range and in the line-of-sight, initiate a casting of at least the selected viewable content to the selected second display. The device is configured to withhold casting to the selected second display, pending confirmation by a user that the selected second display is the intended device to cast the selected viewable content.

### BACKGROUND

### 1. Technical Field

The present disclosure relates generally to electronic devices that output content, and in particular to electronic devices that wirelessly transmit content for output on a wirelessly-connected local output device.

### 2. Description of the Related Art

Portable electronic communication devices, particularly smartphones, have become ubiquitous. People all over the world use such devices to stay connected and to share content using content sharing functionalities of the devices. The content sharing functionalities can enable a user of a mobile device to transmit content to a second electronic device to be presented on a display of the second electronic device to enable the user to view the content using the display of the second device. Examples of content sharing include casting and mirroring. Mirroring creates an exact replica of a device screen on a larger device in real time. Casting allows users to send specific content from their devices to larger screens while continuing to use their devices to complete other tasks. Such techniques enable wireless streaming of content from a device such as a smart phone or a computer to another device such as a television or a speaker.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present innovation are shown and described with respect to the figures presented herein, in which:

FIG. 1 depicts an example first electronic device within which various aspects of the disclosure can be implemented to prevent selected viewable content from being inadvertently cast to a selected second display when the selected second display is not located within an acceptable range of or not in a line of sight relative to the electronic device, according to one or more embodiments.

FIG. 2A depicts an example projection scenario in which a user of an electronic device can project/transmit selected viewable content to a target display selected from among multiple possible target displays located in different rooms in a residence, according to one or more embodiments.

FIG. 2B depicts a user interface by which the user of the electronic device selects the target display from among the multiple possible target displays to cause the electronic device to project/transmit the selected viewable content to the target display, according to one or more embodiments.

FIG. 3 depicts a device display presenting example notifications that can be presented to notify a user of an electronic device that a selection of a target display requires additional confirmation because the selected target display is determined to be at least one of (i) not within an acceptable range, and (ii) not in a line of sight relative to a position of the electronic device, according to one or more embodiments.

FIG. 4 depicts a device display presenting example notification messages to suggest to a user of the electronic device about one or more available target displays that are within the acceptable range and in a line-of-sight relative to the electronic device, according to one or more embodiments.

FIG. 5 is a flow chart that depicts an example method for projecting selected viewable content from an electronic device to a selected target display of an associated electronic device based on the selected target display being positioned within an acceptable range and in a line of sight of a user of the electronic device, according to one or more embodiments.

FIG. 6 is a flow chart that depicts an example method for providing selectable display options when a selected target display is determined to be a potentially incorrect selection to project the selected viewable content to, at least in part based on the location of the electronic device, according to one or more embodiments.

FIG. 7 is a flow chart that depicts an example method for determining alternative target display(s) that can be suggested as a potential target display to project the selected viewable content to when the initially selected target display is determined to be not within the acceptable range and/or not in a line of sight, according to one or more embodiments.

### DETAILED DESCRIPTION

According to some embodiments, the present disclosure provides an electronic device, a method, and a computer program product that enable autonomous selection of a target or second output device, such as a display and/or a speaker, among multiple available target output devices to which the electronic device projects content, based on the relative location of the electronic device and the location of the selected second output device relative to the content consumer. In some video specific embodiments, the disclosure enables autonomous selection of a target or second display among multiple available targets or second displays to which the electronic device projects a viewable content, based on the relative location of the electronic device and the location of the selected second display relative to the content viewer. According to one or more embodiments, the electronic device includes a display, a communications subsystem configurable to connect the electronic device to a select one of a plurality of second electronic devices each having an associated second display, a memory storing a casting module that enables casting of viewable content from the electronic device to at least one second display associated with a second electronic device; and a controller communicatively connected to the display, the communications subsystem, and the memory, the controller being configured to cause the electronic device to, in response to receiving a trigger to project selected viewable content to a selected second display: (i) determine, by evaluating location information of the electronic device and location information of the selected second display, whether the selected second display is located within an acceptable range of and in a line of sight relative to the electronic device; and (ii) in response to determining that the selected second display is within the acceptable range and the line of sight, initiate a casting of the selected viewable content to the selected second display. In one or more embodiments, the electronic device is configured to, in response to determining that the selected second display is not within the acceptable range or the line of sight: (i) generate a notification indicating that the selected second display is not within at least one of the acceptable range or the line of sight; and (ii) render and present the notification within the display of the electronic device, the notification comprising selectable options for responding to the notification. In one or more embodiments, the electronic device is configured to: in response to receiving a first input to proceed with casting to the selected second display, initiate the casting of the selected viewable content to the selected second display; and in response to receiving a second input to not proceed with casting to the selected option, withhold the casting of the selected viewable content and present additional available casting options for selection.

According to one or more embodiments, the method includes receiving a trigger to project selected viewable content to a selected second display; determining, by evaluating location information of the electronic device and location information of the selected second display, whether the selected second display is located within an acceptable range of and a line of sight relative to the electronic device; and in response to determining that the selected second display is within the acceptable range and the line of sight, initiating a casting of at least the selected viewable content to the selected second display. In one or more embodiments, the method comprises, in response to determining that the selected second display is not within the acceptable range and not in a line of sight: (i) generating a notification indicating that the selected second display is not within the acceptable range of and not in the line of sight relative to the location of the electronic device; and (ii) rendering and presenting the notification within the display of the electronic device, the notification comprising selectable options for responding to the notification. In one or more embodiments, the method comprises: in response to receiving a first input to proceed to a selected option, initiating a casting of the selected viewable content to the selected second display; and in response to receiving a second input to not proceed to the selected option, withholding the casting of the selected viewable content and providing additional available casting options for selection.

According to one or more embodiments, the computer program product that includes a non-transitory computer readable storage device and program code on the computer readable storage device that when executed by a processor associated with an electronic device configures the processor to cause the electronic device to provide functionality of the above-described and additional method processes.

The present disclosure addresses issues that arise when a selected viewable content is cast by an electronic device to a selected second display of a second electronic device when the selected second display is located at a location that is not convenient for a user of the electronic device because either the selected second display is not within an acceptable range (e.g., located too far from the user of the electronic device) or the selected second display is not located in the line of sight of the user of the electronic device (e.g., located in another room or separated from the user by a wall). Further, when casting to a selected second display that is not within an acceptable range or not within a line of sight, the selected viewable content can unintentionally be exposed to one or more other persons, such as users of the second electronic device. For example, in a family setting, when the selected viewable content is a movie about World War II that involves killing of people, the user of the electronic device may not want to unintentionally project the movie with the R-rated (violent) content to a second display positioned in a playroom where his/her young children are present instead of a third display located in the sitting room where the user is present.

It is appreciated that, in a scenario where the second electronic device and the selected second display are integrated as one unit, the location of the second electronic device and the location of the selected second display are effectively the same, and the single location can be used to determine whether the display device is located at a position that is within the acceptable range of and the line of sight relative to the position of the electronic device. In a scenario where the second electronic device and the selected second display are not integrated as one unit (e.g., a computer with a system unit and a cable-connected or a wirelessly-connected separate monitor), the location of the selected second display is used to determine whether the selected second display is located at a position that is within the acceptable range of and the line of sight relative to the position of the electronic device. It is appreciated that an acceptable range includes a range where any video presented with the selected second display is viewable to a user of the electronic device (also referred to as viewable range) and/or a range where any audio presented with the selected second display is audible to the user of the electronic device (also referred to as an audible range). It is appreciated when a selected second display is positioned within an acceptable range of the electronic device 100, the selected second display is considered to be within communication range of the electronic device 100, and therefore can receive any casting communication initiated from the electronic device 100. It is also appreciated that when a second display is within the acceptable range and the communication range of the electronic device 100, it is still possible that the second display is not in a line of sight of the user of electronic device 100 because of one or more obstacles.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided, names and reference numerals similar to those of the previous figure(s) are utilized. The specific numerals assigned to the elements are provided solely to aid in the description and are not meant to imply any limitations (structural, functional, or otherwise) on the described embodiments. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of a given implementation, and such references do not limit different element, feature, protocol, or concept names utilized to their particular embodiments. Thus, each term utilized herein is to be given its broadest interpretation given the context in which that term is utilized.

As provided herein, the term “content” is not limited to only the content stored in the electronic device, but can encompass content provided by an external source and retrieved by the electronic device. Further, the content can include a combination of one or more image information, audio information and video information.

As further described below, implementation of the functional features of the disclosure described herein is provided within processing devices and/or structures and can involve use of a combination of hardware, firmware, and several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted examples are not meant to imply architectural or other limitations with respect to the presently described embodiments and/or the general invention. The descriptions of the illustrative embodiments can be read in conjunction with the accompanying figures. Embodiments incorporating teachings of the present disclosure are shown and described with respect to the figures presented herein.

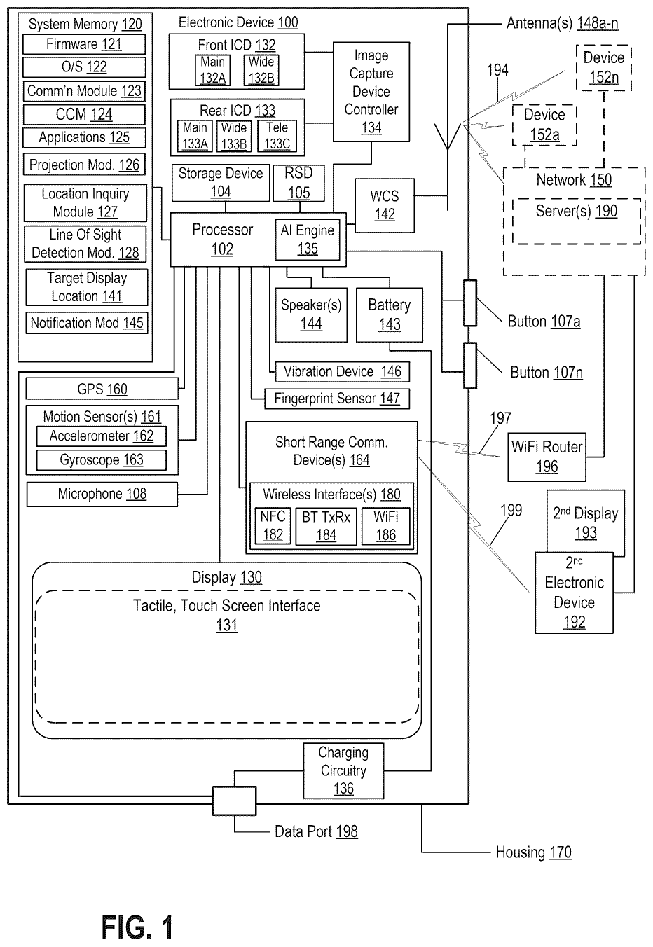

FIG. 1 depicts an example first electronic device within which various aspects of the disclosure can be implemented to prevent selected viewable content from being inadvertently cast to a selected second display when the selected second display is not located within an acceptable range of or not within a line of sight relative to the electronic device, according to one or more embodiments. Examples of such electronic devices include, but are not limited to, mobile devices, notebook computers, a mobile phones, digital cameras, smart watches, tablet computers, and communication devices. Electronic device 100 (also referred to as a first electronic device) includes processor 102, which is communicatively coupled to storage device 104, system memory 120, input devices, introduced below, output devices, such as display 130, and image capture device (ICD) controller 134. Processor 102 can include processor resources such as a central processing unit (CPU) that support computing, classifying, processing, and transmitting of data and information. Electronic device 100 includes a plurality of image capturing devices, presented as front and rear facing cameras 132, 133. The ICD controller 134 may perform or support functions such as, but not limited to, selecting and activating an active camera from among multiple cameras. Throughout the disclosure, the term image capturing device is utilized interchangeably with any one of front or rear facing cameras 132, 133.

System memory 120 may be a combination of volatile and non-volatile memory, such as random-access memory (RAM) and read-only memory (ROM). System memory 120 can store program code or similar data associated with firmware 121, an operating system 122, communication (comm'n) module 123, camera control module (CCM) 124, applications 125, projection module 126, location inquiry module 127, line of sight detection module 128, and notification module 145. Communication module 123 includes program code that is executed by processor 102 to enable electronic device 100 to communicate with other external devices and systems.

The projection module 126 includes program code that is executed by processor 102 to enable the electronic device 100 to project selected viewable content accessible by the electronic device 100 to a selected second display of a second electronic device 192. During implementation of the described features, there may be one or more second displays available for projection, and a user of the electronic device 100 can select a second display from the one or more available second displays using a user interface. Different techniques can be used by electronic device 100 (e.g., via execution of code of the projection module 126 by processor 102) to project the selected viewable content to the selected second display. Techniques corresponding to the projection of the selected viewable content can be referred to as casting or mirroring, where all of the selected viewable content generated for presentation on the display 130 of the electronic device 100 can be presented (or duplicated) on the selected second display of the second electronic device 192. For purposes of the disclosure, projection is utilized interchangeably with and is intended to also mean or be inclusive of casting or mirroring of selected viewable content.

In one or more embodiments, processor execution of the code of the location inquiry module 127 can initiate generation of a request for location information for the selected second display 193. A request for the location information can be transmitted to the second electronic device 192, and the location information for the selected second display 193 can be received from the second electronic device 192. For example, the second electronic device 192 can be configured to include a GPS device to determine an absolute location based on GPS coordinates. The GPS location of the second electronic device 192 (which can also be used as the GPS location of the corresponding selected second display) can then be transmitted to the electronic device 100. The processor 102 of the electronic device 100 can execute code to determine the GPS coordinates of the electronic device 100 using the GPS device 160 and determine the relative location of the selected second display 193 from the electronic device 100 based on the received GPS location of the second electronic device 192. In the alternative, or in addition, the second electronic device 192 can be configured to employ ultra-wideband (UWB) technology where UWB anchors and UWB tags are used to determine a position of a UWB tag. For example, a UWB tag can be applied to a second display and pings from the UWB tag can be heard by the UWB anchors installed in various positions with known location information. The time that each anchor hears the ping is recorded and the time difference can then be used by a server computer (or electronic device 100) to determine the position of the selected second display 193. The location information of available second displays and corresponding second display identifiers (e.g., living room TV, downstair TV, bedroom 1 TV, etc.) can be stored as second display locations 141. Other techniques to determine the absolute location and the relative location of the second electronic device 192 can also be used. In one or more embodiments, location information of the available second displays can also be stored in a cloud-based storage associated with a server computer system (e.g., server 190) and can be retrieved by the location inquiry module 127.

In one or more embodiments, processor execution of the code of the line-of-sight detection module 128 can initiate generation of a request for line-of-sight information for the selected second display. A request for the line-of-sight information can be transmitted to the second electronic device 192. For example, the electronic device 100 can be configured to include a transmitter to transmit a radiation or acoustic wave, and the second electronic device 192 can be configured to include a receiver to receive the wave that travels from the electronic device 100. Any obstacle (e.g., a wall) that may exist between the electronic device 100 and the second electronic device 192 can disrupt the wave propagation path preventing the second electronic device 192 from receiving the waves transmitted from the electronic device 100. The line-of-sight information received from the second electronic device 192 can include information indicating whether the waves propagated from the first electronic device 100 are received by the second electronic device 192. The line-of-sight information received from the second electronic device 192 can also be stored in the second display locations (target display locations) 141 along with the corresponding second display identifier. Other techniques to determine the line of sight can also be used.

In one or more embodiments, a range threshold is used to determine whether a selected second display is within an acceptable range. For example, the range threshold can be set at 20 feet, and any selected second display that is positioned at a location further than 20 feet from the electronic device 100 can be considered as not within the acceptable range, even if the selected second display is determined to be within the line of sight of the electronic device 100. The location information and the line-of-sight information of a second display can be changed due to movement or repositioning of the second display or movement of electronic device 100. In one or more embodiments, the location information and the line-of-sight information for each of the one or more available second displays are determined periodically, and the updated location information and updated line-of-sight information are stored in the second display location 141.

It is appreciated that a second display is available when it is powered on (or online), but not available when it is powered off (or offline). For example, a second display can be within the acceptable range and in the line of sight relative to the electronic device 100 and can be used for projection during a first time period, but that same second display located at the same location may not be available for projection because it has been set offline. As a specific example, the user 201 cannot project or cast a selected viewable content from the electronic device 100 to a TV in the living room when the TV is powered off.

In one or more embodiments, processor execution of code of the notification module 145 can also include in the notification selectable options to enable the user of the electronic device 100 to decide whether to proceed with or to abort the projection of the selected viewable content to the selected second display 193. In one or more embodiments, processor execution of code of the notification module 145 can further include suggestions of an alternative second display that is positioned at a location that is within the acceptable range and within the line of sight of the electronic device 100. Also, in one or more embodiments, processor execution of code of the notification module 145 can further include suggestions that the user of the electronic device 100 relocate to a different location where there is a second display that is within the acceptable range and located within a line of sight.

Although depicted as being separate from applications 125, the CCM 124, the projection module 126, the location inquiry module 127, the line-of-sight detection module 128, the notification module 145, and the communication module 123 may each be implemented as an application. Processor 102 loads and executes program code of the various modules stored in system memory 120. Examples of program code that may be loaded and executed by processor 102 include program code associated with communication module 123 and applications 125 and program code associated with the projection module 126, location inquiry module 127, line-of-sight detection module 128, and the notification module 145.

According to one or more embodiments, electronic device 100 includes removable storage device (RSD) 105, which is inserted into an RSD interface (not shown) that is communicatively coupled via system interlink to processor 102. According to one or more embodiments, RSD 105 is a computer readable storage device encoded with program code and corresponding data, and RSD 105 can be interchangeably referred to as a non-transitory computer program product or non-transitory computer readable storage device having non-transitory computer readable program code/instructions. RSD 105 may have a version of projection module 126 stored thereon, in addition to other program code. Processor 102 can access RSD 105 to provision electronic device 100 with program code that, when executed by processor 102 causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Front facing cameras (or image capture device (ICD)) 132 are communicatively coupled to ICD controller 134, which is communicatively coupled to processor 102. ICD controller 134 supports the processing of signals from front facing cameras 132. Front facing cameras 132 can capture images that are within the field of view (FOV) of image capture device 132. Electronic device 100 includes several front facing cameras 132. First front facing camera 132A is a main camera that captures a standard angle FOV. Second front facing camera 132B is wide angle camera that captures a wide angle FOV. Front facing cameras 132A and 132B can be collectively referred to as front facing cameras 132A-132B or front facing camera(s) 132. While two front facing cameras 132A-132B are shown, electronic device 100 can have more or less than two front facing cameras.

Electronic device 100 further includes several rear facing cameras 133. First rear facing camera 133A is a main camera that captures a standard angle FOV. Second rear facing camera 133B is wide angle camera that captures a wide angle FOV. Third rear facing camera 133C is a telephoto ICD that captures a telephoto FOV (zoom or magnified). Each rear facing camera 133A, 133B, and 133C is communicatively coupled to ICD controller 134, which is communicatively coupled to processor 102. ICD controller 134 supports the processing of signals from rear facing cameras 133A, 133B and 133C. Rear facing cameras 133A, 133B and 133C can be collectively referred to as rear facing cameras 133A-133C or rear facing cameras 133. While three rear facing cameras are shown, electronic device 100 can have less than three rear facing cameras. For example, device 100 can only have one or two rear facing cameras or can have more than three rear facing cameras.

Electronic device 100 can further include data port 198, charging circuitry 136, and battery 143. Electronic device 100 further includes microphone 108, one or more output devices such as speakers 144, and one or more input buttons 107a-107n. Input buttons 107a-107n may provide controls for volume, power, and image capture device 132. Microphone 108 can also be referred to as audio input device 108. Microphone 108 and input buttons 107a-n can also be referred to generally as input devices.

Electronic device 100 further includes wireless network communication subsystem (WNCS) 142, which is coupled to antennas 148a-148n. According to one or more embodiments, WNCS 142 can include a communication module with one or more baseband processors or digital signal processors, one or more modems, and a radio frequency (RF) front end having one or more transmitters and one or more receivers. WNCS 142 and antennas 148a-148n allow electronic device 100 to communicate wirelessly with wireless network 150 via transmissions of communication signals 194 to and from network communication devices 152a-152n, such as base stations or cellular nodes, of wireless network 150. In one embodiment, network communication devices 152a-152n contain electronic communication equipment to allow communication with electronic device 100.

Short range communication device 164 is a low powered transceiver that can wirelessly communicate with other devices. Short range communication device 160 includes wireless interface 180 configured using one or more of software and hardware to enable the electronic device 100 to connect to other devices using different communication protocols. For example, the wireless interface 180 includes one or more of near field communication (NFC) device 182 for connecting to a NFC network, a Bluetooth transceiver device 184 for connecting to a Bluetooth network, and/or a wireless fidelity (Wi-Fi) device 186 for connecting to a wireless fidelity (WiFi) network.

Wireless network 150 is communicatively coupled to WiFi router 196. Wireless network 150 further allows electronic device 100 to wirelessly communicate with second electronic devices 192 via communication signals 197 transmitted by short range communication device(s) 164 to and from WiFi router 196. The second electronic devices 192 can be similarly connected to wireless network 150 via one of network communication devices 152a-n. According to one or more embodiments, wireless network 150 can include one or more servers 190 that support exchange of wireless data and video and other communication between electronic device 100 and second electronic device 192.

In one embodiment, electronic device 100 can receive internet or Wi-Fi based calls via short range communication device 164. In one embodiment, electronic device 100 can communicate with WiFi router 196 wirelessly via short range communication device 164. In an embodiment, WNCS 142, antennas 148a-n and short-range communication device(s) 164 collectively provide communication interface(s) of electronic device 100. These communication interfaces enable electronic device 100 to communicatively connect to at least one second electronic device 192 directly or via at least one network. In one or more embodiments, the projection of the selected viewable content performed by the projection module 126 to the second display can be supported/established by a peer-to-peer connection using one of these short-range communication devices 164. For example, short range communication device 164 can wirelessly communicate with second electronic device 192 via local communication signals 199.

Electronic device 100 further includes vibration device 146, fingerprint sensor 147, global positioning system (GPS) device 160, and motion sensor(s) 161. Vibration device 146 can cause electronic device 100 to vibrate or shake when activated. Vibration device 146 can be activated during an incoming call or message in order to provide an alert or notification to a user of electronic device 100. According to one aspect of the disclosure, display 130, speakers 144, and vibration device 146 can generally and collectively be referred to as output devices. Fingerprint sensor 147 can be used to provide biometric data to identify or authenticate a user. GPS device 160 can provide time data and location data about the physical location of electronic device 100 using geospatial input received from GPS satellites.

Motion sensor(s) 161 can include one or more accelerometers 162 and gyroscopes 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. According to one or more embodiments, the measurements of these various sensors can also be utilized by processor 102 in the determining of the context of a communication. Electronic device 100 further includes housing 170 that contains/protects the components of electronic device 100.

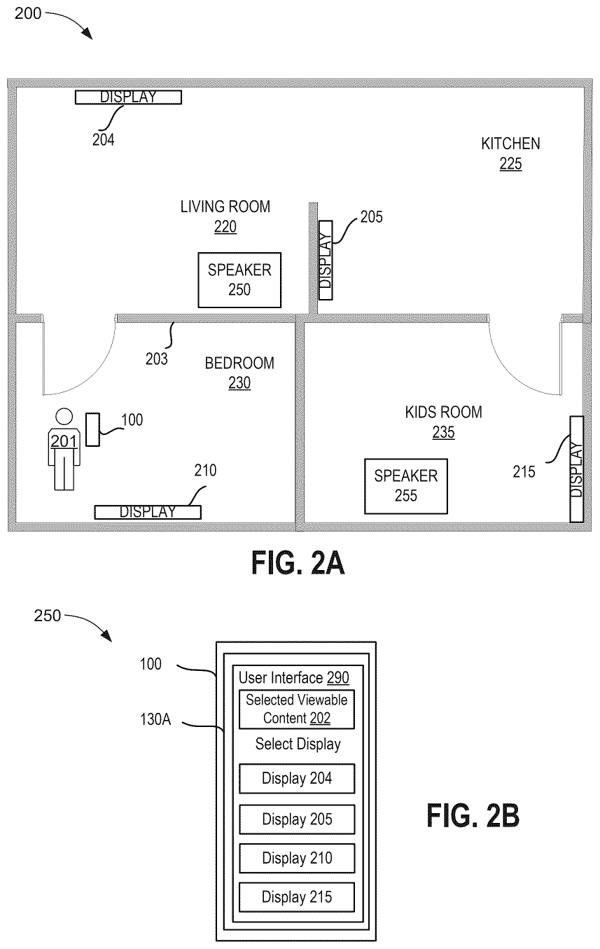

FIG. 2A depicts an example projection scenario by which an electronic device projects/transmits a selected viewable content to a target display among multiple possible target displays located in different rooms in a residence, according to one or more embodiments. The different rooms in the residence include the living room 220, the kitchen 225, the bedroom 230, and the kids'room 235. Located within the living room 220 are first display 204 and speaker 250. Located within the kitchen 225 is second display 205. Located within the bedroom 230 is third display 210, and located within the kids room 235 is fourth display 215 and second speaker 255. As shown in diagram 200, the user 201 has electronic device 100 and is located within the bedroom 230. Each of the rooms is separated from the other rooms by at least one wall (or obstacle) such as obstacle 203. As such, the second display 205 is not within the line-of-sight of the user 201 (or of the electronic device 100) because of at least the obstacle 203. Similarly, the fourth display 215 is not in the line-of-sight of the user 201.

FIG. 2B depicts a user interface 290 by which a user 201 of an electronic device 100 selects a target display among multiple possible target displays to cause the electronic device 100 to project/transmit a selected viewable content 202 to, according to one or more embodiments. The projection user interface 290 can be opened by the user 201 by activating a projection/cast app/application/module 126 and user 201 can then initiate projection by selecting a project/cast command within a projection/cast user interface 290. The projection function can be performed by the processor 102 executing code of the projection module 126 and can cause a copy of a selected viewable content 202 to be projected to a selected target display. It is appreciated that there can be viewable content that a user of the electronic device 100 can select via a user interface 290 to project. Further, selected viewable content can be also presented within the display 130A, as depicted in diagram 250. In addition, or in the alternative, a link to selected viewable content 202 can also be presented within the display 130A. For example, instead of showing the WWII movie being played within the display 130A, a link such as “WWII-How the war started” is presented within the display 130A, and the projection of the link causes the movie to begin playing on the selected target display.

As depicted in diagram 250, the user 201 can select one of the first display 204, the second display 205, the third display 210, and the fourth display 215 as four potential target displays to which to project the selected viewable content 202. It is appreciated that the potential target displays depicted in diagram 250 can include all the target displays that the electronic device 100 is able to communicatively connect to and/or has previously been made aware of as potential target displays for content projection/casting. For example, the electronic device 100 and the electronic devices associated with the first display 204, the second display 205, the third display 210, and the fourth display 215 can be communicatively connected to the same network, and therefore the electronic device 100 is aware of the existence of the other devices on the network. In addition, or in the alternative, each electronic device can be configured to transmit and receive signals to announce the existence of the device to nearby devices. Other techniques to identify nearby devices can also be used. It is appreciated that not all of the available potential target displays are within the acceptable range and in a line of sight of the electronic device 100. For example, referring to diagram 200, the third display 210 in the bedroom 230 is determined to be within the acceptable range (e.g., within 20 ft) and in a line of sight of the electronic device 100, while the fourth display 215 in the kids room 235 is determined to be not within the acceptable range and not in the line-of-sight. The first display 204 in the living room 220 can be in the line-of-sight of the user 201 when the door to the bedroom 230 is opened, but it may not be located within the acceptable range.

Each second electronic device associated with an available target display can be assigned a unique identifier (e.g., a machine or location-specific name). In one or more embodiments, when the second electronic device communicates with nearby devices (including the electronic device 100) to announce the presence of the second electronic device, the identifier of the second electronic device can also be communicated to the nearby electronic devices. In one or more embodiments, the identifier of a second electronic device can also be used as the identifier of the corresponding target display. In one or more embodiments, the identifier of a second electronic device can be used as an identifier of a related target display, and the identifier can be presented in the user interface 290. For example, the user interface 290 can include selectable options such as “living room display”, “kitchen display”, etc.

In diagram 200, the third display 210 is depicted as the closest target display to the user 201, the second display 205 is depicted as the next closest target display, the third display 204 is depicted as the next closest target display after the second display 205, and the fourth display 215 is depicted as the furthest target display from the user 201. The first display 204 is potentially positioned within a line-of-sight but it is outside of an acceptable range. The fourth display 215 is not in the line-of-sight and is outside of an acceptable range relative to a position of the user 201. The second display 205 is positioned within the acceptable range based on the same range threshold; however, the second display 205 is not in a line-of-sight of the user 201 due to the obstacle 203, and any selected viewable content cast from the electronic device 100 to the second display 205 is not viewable by the user 201 at the user's current position. The location of the second display 205 therefore cannot be used as a location to project or cast a selected viewable content 202 from the electronic device 100.

It is appreciated that, although the examples depicted in FIG. 2B and throughout the application refers to the selected viewable content 202, the disclosure can also apply to audible content whereby the selected content can be audible content such as, for example, an MP3 song. Similarly, even though FIG. 2B depicts the first display 204, the second display 205, the third display 210 and the fourth display 215 as potential selected targets, one or more of the potential selected targets can be an audio device such as, for example, a smart speaker (or an audio system) 250 in the living room 220 and a speaker (or an audio system) 255 in the kids room 235. Further, some embodiments can apply to audio only content and the selection of a target output device can then be of target audio output devices only. Accordingly, the mirroring or casting can be to an audio output device, such as a smart speaker. It is further appreciated that most viewable content incorporates audio that is presented along/concurrently with the viewable content via integrated speakers of the selected display.

In one or more embodiments, when the user 201 selects a display (e.g., second display 205) to project the selected viewable content 202 to, the processor 102 executes code of the location inquiry module 127 to cause the electronic device to generate and transmit a request for the location information for the selected second display 205. The location information for the selected second display 205 can be determined by the second electronic device associated with the selected second display 205 using a GPS device and/or using UWB anchors and tags. In one embodiment that uses GPS location, the processor 102 can use the GPS device 160 to determine the location information for electronic device 100. The processor 102 can use the location information for the electronic device 100 and the location information received for the selected second display 205 to determine a distance between the selected second display 205 and the electronic device 100 and the user 201. In an alternate embodiment, the GPS location of the displays can be known and provided via a location map of the home/space, such that the electronic device only has to determine its own GPS location and use the reference GPS locations of the second devices to determine the distance to each of the second display devices.

According to one aspect, processor 102 can execute code of the line-of-sight detection module 128 to determine whether the selected second display 205 is in a line of sight of the electronic device 100. For example, the determination of line of sight can be performed using wave propagation between a transmitter in the electronic device 100 and a receiver in the second electronic device associated with the selected second display 205. As depicted in diagram 200, the selected second display 205 is within the acceptable range but is not in a line of sight of the electronic device 100. Thus, the selection of the second display 205 can trigger the processor 102 to generate warning notifications to be presented to the user 201 at electronic device 100.

In a scenario where the user 201 selects the first display 204, similar location determination and line-of-sight operations are performed by the processor 102 to determine that the first display 204 is not within the acceptable range even though the first display 204 is in a line-of-sight (e.g., viewable through the opened door of the bedroom 230) of the electronic device 100 and the user 201. The determination that the first display 204 is not within the acceptable range can trigger the processor 102 to generate a warning notification to be presented to the user 201 at the electronic device 100.

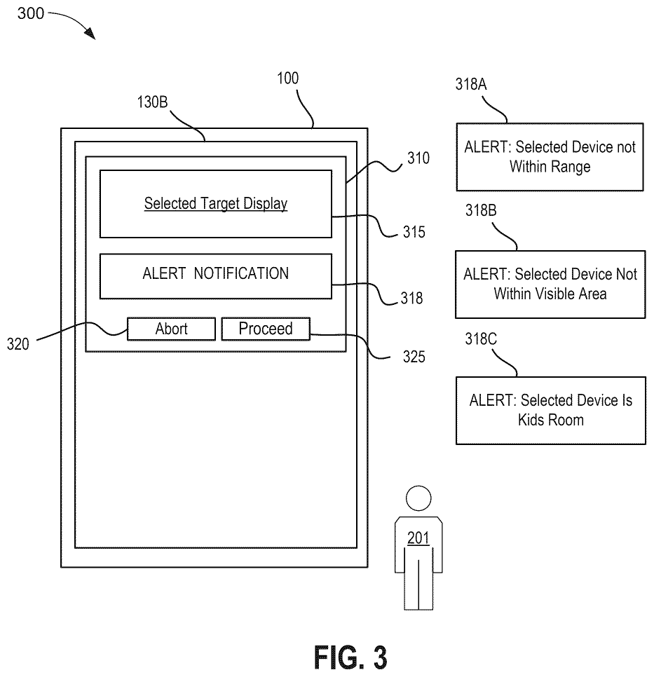

FIG. 3 depicts a device display presenting example notifications that can be presented to notify the user 201 of the electronic device 100 that a selection of a target display requires additional information because the selected target display is determined to be at least one of (i) not within an acceptable range and/or (ii) not in a line of sight relative to a position of the electronic device, according to one or more embodiments. Depending on the environment, the selection of one of the first display 204, the second display 205, the third display 210 and the fourth display 215 depicted in FIG. 2A can be intentional, unintentional/accidental, or due to not knowing where the first display 204, the second display 205, the third display 210 and the fourth display 215 are positioned. As an example of not knowing the positions of the first display 204, the second display 205, the third display 210 and the fourth display 215, in an office setting, the user 201 can be an office employee who wants to project selected viewable content 202 to a target display for a business meeting. However, because the user 201 is unfamiliar with the conference rooms where the different displays are positioned, the user 201 can accidentally select a target display positioned in an incorrect conference room.

When a selected target display is determined to be either not within the acceptable range or not in a line-of-sight, or both, of the electronic device 100, the processor 102 executes code of the notification module 145 to cause the notification message 310 to be presented within the display 130B. The notification message 310 can include an alert notification 318 about the selection of the target display. For example, the alert notification 318 can be one or more of the alerts 318A, 318B, and 318C. The first alert 318A can be presented when the selected target display is determined to be not within the acceptable range. The second alert 318B can be presented when the selected target display is determined to be not in a line-of-sight. The third alert 318C can be presented when the selected target display is determined to be positioned in a room (e.g., kids room 235) that is other than a room (e.g., bedroom 230) that the user 201 is positioned in. In one or more embodiments, the notification message 310 can include an identifier associated with the selected target display 315. For example, the information can indicate that the selected target display is associated with the identifier “Main Conference Room Monitor” or “Living Room TV”.

In one or more embodiments, when a selected target display is determined to be not in an acceptable range or not in a line-of-sight, the processor 102 withholds casting to the selected target display, pending confirmation by the user 201 that the selected target display is the intended device to cast the selected viewable content. For example, the user 201 can select the proceed option 325 to confirm that the selected target display is the intended device. Alternatively, the user 201 can cause the processor 102 to withhold the casting by selecting the abort option 320 so that the user 201 can select a different target display.

For example, when the user 201 intends to have the selected viewable content 202 projected to the second display 205 because the user 201 already plans to move from a current position (e.g., within the bedroom 230) to a different position (e.g., within the kitchen 225) so that the second display 205 is within the line-of-sight of the user 201, then the selection is intentional and correct. In that situation, the user 201 can select the proceed option 325. In the situation where the user 201 recognizes from the notification message 310 that the second display 205 is either not within an acceptable range or not in a line-of-sight, the user 201 can select the abort option 320 and select another target display using the user interface shown in FIG. 2B.

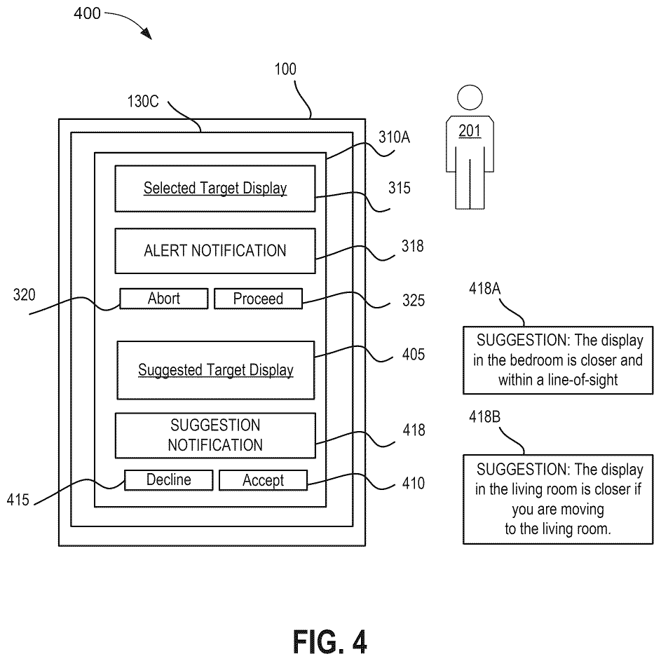

FIG. 4 depicts a device display presenting example notification messages to suggest to the user 201 of the electronic device 100 about one or more available target displays that are within the acceptable range and in a line-of-sight relative to the electronic device 100, according to one or more embodiments. As previously described, the location information and the line-of-sight information for each of the one or more available target displays can be determined periodically and the updated location information and updated line-of-sight information can be stored as target display location 141. In one or more embodiments, the processor 102 can be configured to analyze the target display location 141 and the location information of the electronic device 100 to determine which of the available target displays are within the acceptable range of and in the line-of-sight relative to user 201 of the electronic device 100 and to identify the second displays that can be suggested to the user 201.

The number of available target displays that can satisfy the acceptable range and the line-of-sight requirements can vary depending on the position of the electronic device 100, and can range from zero to many. In one or more embodiments, when a selected target display is determined to be within an acceptable range and in the line-of-sight of the user 201 of the electronic device 100, the projection/casting of the selected viewable content can start shortly after such determination. In the scenarios when the selected target display is determined to be not within the acceptable range or not within a line-of-sight, the notification message 310A can be generated. The notification message 310A can be presented within the display 130C and can include information about the selected target display and information about one or more suggested target displays. It can be appreciated that, in the scenarios where an alternative target display is not available, it may not be necessary for the notification message 310A to be presented. As depicted in diagram 400, using the example available target displays of FIG. 2A, when the selected target display 315 is determined to be not in a line-of-sight and/or not within an acceptable range, a suggested target display 405 (e.g., Bedroom Display) can be provided in the notification message 310A as an alternative target display.

The alternative target display can be suggested because the alternative target display has been determined to be within the acceptable range and in the line-of-sight relative to the user 201 and/or the electronic device 100. For example, using the example depicted in FIG. 2A, the third display 210 can be suggested after the user 201 selects the second display 205. In one or more embodiments, the suggested target display 405 is presented with a selectable accept option 410 to accept the suggestion and selectable decline option 415 to decline the suggestion.

In one or more embodiments, in addition to presenting the suggested target display 405, the notification message 310A can include suggestion notification 418 describing information about the alternative target display. For example, the suggestion notification 418 can be one of the suggestions 418A and 418B. The suggestion 418A can be presented when the alternative target display is determined to be within the acceptable range and within a line-of-sight. The suggestion 418B can be presented when the alternative target display is determined to be the closest display when the user 201 moves from the current position to another position in the living room 220. In one or more embodiments, when there is more than one available target display in the acceptable range and the line-of-sight relative to a position of the user 201 of the electronic device 100, each available target display can be presented together with the corresponding selectable accept option 410 and decline option 415.

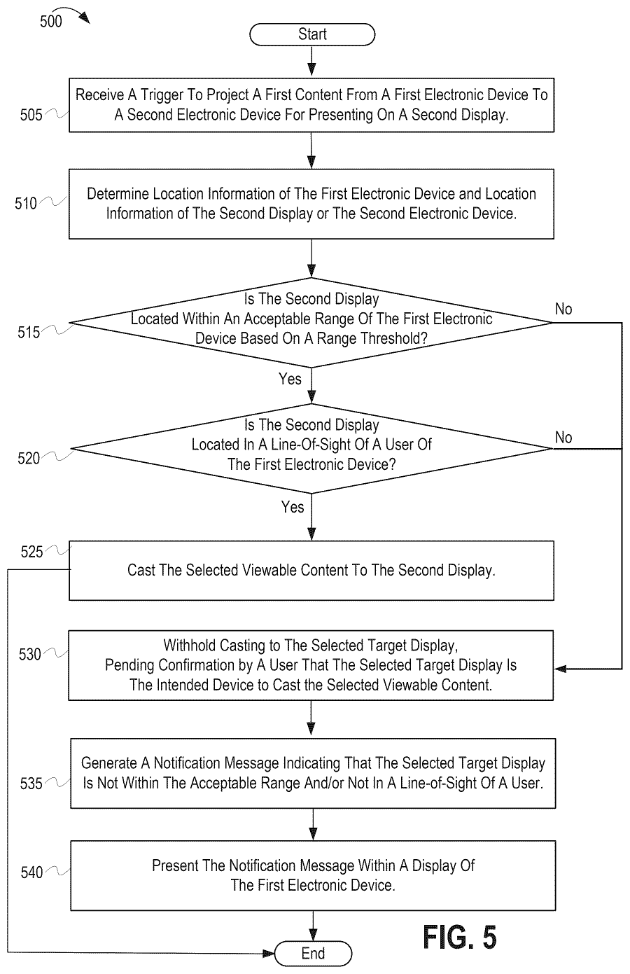

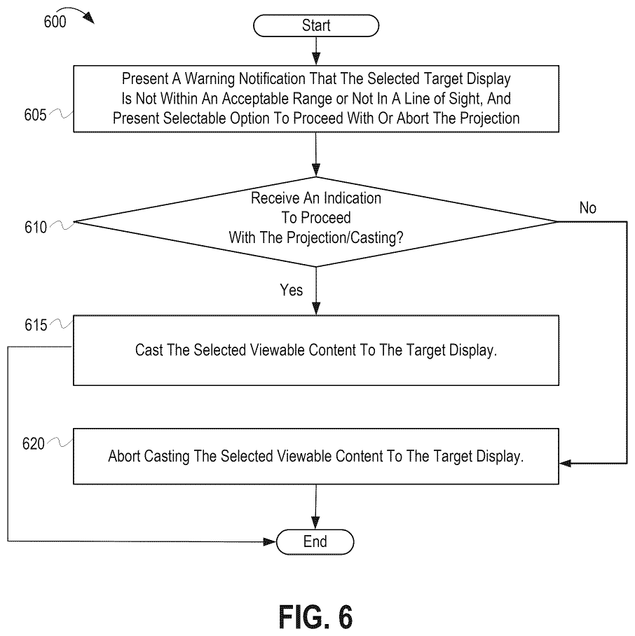

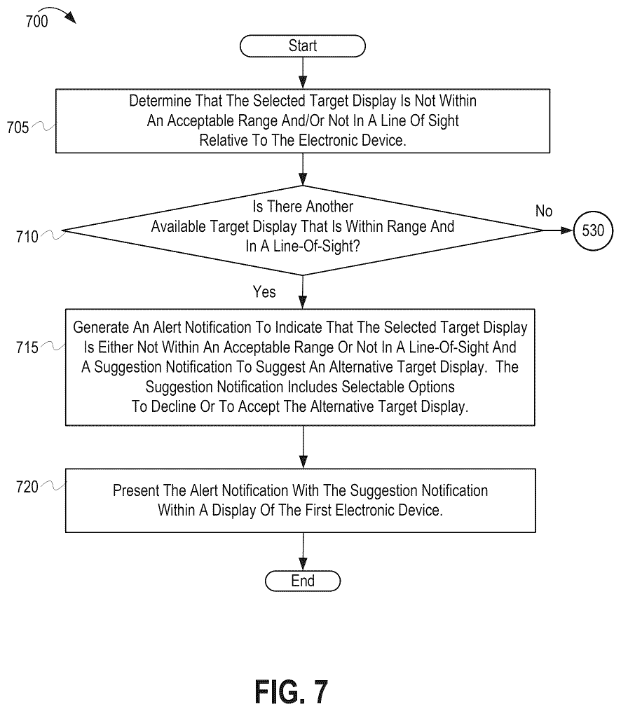

FIGS. 5, 6 and 7 are flowcharts that depict different methods for evaluating whether a target display selected to project selected viewable content is a good selection based on the relative location of the user device, according to respective embodiments. The methods are implemented to determine whether to project the selected viewable content to a selected target display based on the target display being within an acceptable range of and a line of sight relative to the electronic device 100. In at least one embodiment, the electronic device 100 is controlled by processor 102, which executes code of the projection module 126, the location inquiry module 127, and the line-of-sight detection module 128 (FIG. 1). The processor 102 is configured to cause the electronic device 100 to perform the functionality described for method 500 (FIG. 5), method 600 (FIG. 6), as well as method 700 (FIG. 7). Some of the described processes can be performed by the AI engine 135, operating within electronic device 100.

The description of methods 500/600/700 is provided with general reference to the specific components illustrated within the preceding FIGS. 1-4, and specific components referenced in methods 500/600/700 may be identical or similar to components of the same name used in describing preceding FIGS. 1-4.

FIG. 5 is a flow chart that depicts an example method for projecting selected viewable content from an electronic device to a selected second display of a second electronic device based on the selected second display being positioned within an acceptable range and in a line of sight of the electronic device, according to one or more embodiments. The method 500 can be performed using the electronic device 100 of FIG. 1 executing instructions of the projection module 126 to project a selected viewable content to a second display of a second electronic device 192. The method 500 starts at block 505 where a trigger is received to project the selected viewable content from the electronic device 100 to a second electronic device 192 for presentation on the selected target display. The trigger can be initiated by the user 201 of the first electronic device 100 issuing a projection command via a user interface. An example of a user interface that the user 201 can use to select a target display from multiple available target displays is depicted in diagram 200.

At block 510, the method 500 includes determining a location of the selected target display and/or the associated electronic device. The determination can include the processor 102 requesting location information for the selected target display. The request can be transmitted to an electronic device associated with the selected target display. The processor 102 can also determine the location information of the electronic device 100 using the GPS device 160.

At block 515, the processor 102 determines whether the position of the selected target display is within an acceptable range of the electronic device 100. The determination can be performed using a pre-determined range threshold, the location information of the selected second display, and the location information of the electronic device 100. For example, the range threshold can be specified by the user 201 before issuing the projection command described in block 505. From block 515, when the selected target display is not within the acceptable range, the method 500 continues to block 530. From block 515, when the selected target display is within the acceptable range, the method 500 continues to block 520.

At block 520, the processor 102 executes code to determine whether the position of the selected target display is in a line-of-sight of the electronic device 100. The determination can be performed using wave propagation with a transmitter and a receiver. It is appreciated that the selected target display can be in a line-of-sight of the user of the electronic device 100 when both devices are positioned in the same room. When the processor 102 determines that the selected target display is not in a line-of-sight of the user of the electronic device 100, the method 500 continues to block 530. When the processor 102 determines that the selected target display is in a line-of-sight of the user of the electronic device 100, the method 500 continues to block 525 where the selected viewable content is projected or cast to the selected target display. The method 500 ends after block 525.

At block 530, the processor 102 withholds casting to the selected target display, pending confirmation by a user that the selected second display is the intended device to cast the selected viewable content. At block 535, processor 102 generates a notification message 310 including an alert notification to indicate that the selected target display is not within the acceptable range of or not in a line-of-sight of the electronic device 100. At block 540, the processor 102 presents the notification message 310 within the display 130A (and/or audibly with a speaker) of the electronic device 100. The method 500 ends after block 535.

FIG. 6 is a flow chart that depicts an example method for providing selectable display options when a selected target display is determined to be a potentially incorrect selection to project the selected viewable content to, at least in part based on a location of the electronic device, according to one or more embodiments. The method 600 can be performed using the electronic device 100 of FIG. 1 executing instructions of the notification module 145 to notify the user 201 about the selected target display. The method 600 starts at block 605 where the notification message 310 is presented via the display 130A. The notification message 310 includes a description about whether the position of the selected target display is not within the acceptable range and/or the selected target display is not in a line-of-sight of the electronic device 100. The notification message 310 further includes selectable option to enable the user 201 to abort the projection or to proceed/continue with the projection.

At block 610, the processor 102 determines whether the option to proceed/continue 325 has been selected. When there is no indication to proceed with the projection or an indication to abort the projection, the method 600 continues to block 620 where the projection (e.g., casting) of the selected viewable content is aborted. The method 600 ends after block 620. From block 610, when there is an indication to proceed with the projection, the method 600 continues to block 615 where the projection (e.g., casting) of the selected viewable content to the selected target display continues. The method 600 ends after block 615.

FIG. 7 is a flow chart that depicts an example method for determining an alternative target display that can be suggested as a potential target display to which to project the selected viewable content when the initially selected target display is determined to be not within the acceptable range and/or not in a line of sight, according to one or more embodiments. The method 700 can be performed using the electronic device 100 of FIG. 1 executing instructions of the notification module 126 to notify the user 201 about the available alternative target display. The method 700 starts at block 705 where the processor 102 determines that the selected target display is not within the acceptable range and/or not in a line-of-sight relative to a user 201 of the electronic device 100. At block 710, the processor 102 determines whether there are other available target displays that satisfy the acceptable range and the line-of-sight requirements. For example, the processor 102 can use the location information of the electronic device 100 and the location information and line of sight information related to an available target display, as stored in the target display location 141, to determine if the available target display satisfies the acceptable range and the line-of-sight requirements.

From block 710, when there is no available target display that satisfies the acceptable range and the line-of-sight requirements, the method 700 continues to block 530 of FIG. 5. Alternatively, when there is an available target display that satisfies the acceptable range and the line-of-sight requirements, the method 700 continues to block 715 where the notification message 310A is generated to indicate that the selected target display is not within the acceptable range and/or not in a line of sight of the electronic device 100. The notification message 310A further includes information about a suggested target display that can be selected as an alternate second display for the projection of the selected viewable content. The notification message 310A also includes selectable options to enable the user 201 to accept or to decline the suggestion of the alternative target display. An example of the notification message 310A with the suggested alternative target display is depicted in diagram 400 of FIG. 4. At block 720, the notification message 310A is presented to the user. Selection by the user of the alternate target display can cause processor 102 to project the selected second content to the alternate target display. The method 700 ends after block 720.

According to one or more embodiments, one or more of methods 500/600/700 further include the processor determining whether a selected target display is positioned within an acceptable range based on a position of the selected target display and based on a range threshold. The acceptable range includes at least one of a viewable range and an audible range. The selected viewable content includes at least one of a video content and an audio content.

According to one or more embodiments, one or more of methods 500/600/700 further include the processor 102 presenting a user interface showing identifier information of the one or more available target displays determined to be positioned within the acceptable range and in a line of sight relative to a location of a user 201 of the electronic device to enable a user 201 of the electronic device 100 to select an appropriate at least one target electronic device to project the at least one selected viewable content to for localized user consumption. In response to receiving a selection of identifier information of the at least one target display, the processor 102 can further generate and issue a request for location information about the at least one target display, the location information including at least one of an absolute location, a relative location from the electronic device, and line of sight information relative to the user 201 of the electronic device 100.

Accordingly, by implementing the above-described features, the present disclosure protects a user from inadvertently projecting a selected viewable content to a target display instead of an intended target display when the target display is determined to be not within an acceptable range or not within a line-of-sight or both relative to a position of the user of an electronic device.

Aspects of the present innovation are described above with reference to flowchart illustrations and/or block diagrams of methods, apparatuses (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is not intended that the innovation be limited to the particular embodiments disclosed for carrying out this innovation, but instead that the innovation include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

1. An electronic device comprising:
a display;
a communications subsystem configurable to connect the electronic device to one of a plurality of second electronic devices each having an associated second display;
a memory comprising a projection module that enables casting or mirroring of viewable content from the electronic device to at least one second display associated with a second electronic device; and
a controller communicatively connected to the display, the communications subsystem, and the memory, and which configures the electronic device to:
in response to receiving a trigger to project selected viewable content to a selected second display of a second electronic device, the second display being a physical display:
evaluate location information of the electronic device and location information of the selected second display to determine whether the selected second display is located within an acceptable range of and in a line of sight relative to the electronic device; and
in response to confirming that the second electronic device is within the acceptable range and in the line-of-sight, initiate casting/mirroring of at least the selected viewable content from the electronic device to the second display for presentation on the second display.

2. The electronic device of claim 1, wherein the controller is configured to:
in response to determining that the second display is not at least one of within the acceptable range or in the line-of-sight:
withhold casting/mirroring to the selected second display, pending confirmation by a user that the selected second display is an intended device to which to cast the selected viewable content;
generate a notification indicating that the second electronic device is not within at least one of the acceptable range or the line of sight of the electronic device; and
render and present the notification within the display of the electronic device, the notification comprising selectable options for responding to the notification.

3. The electronic device of claim 2, wherein the controller is configured to:
in response to receiving a first input to proceed with projecting the selected viewable content to the selected second display that is not within at least one of the acceptable range or the line of sight, initiate the casting/mirroring of the selected viewable content to the selected second display; and
in response to receiving a second input to not proceed with projecting the selected viewable content, withhold the casting/mirroring of the selected viewable content.

4. The electronic device of claim 1, wherein to determine whether the second electronic device is within the acceptable range of the electronic device, the controller is configured to:
request the location information of the second display;
responsive to receiving the location information of the second display, determine a distance between the second display and the electronic device using current location information of the electronic device and the location information of the second electronic device; and
determine that the second display is within the acceptable range based on the distance between the second display and the electronic device being less than a range threshold.

5. The electronic device of claim 1, wherein to determine whether the second electronic device is positioned in the line of sight of the electronic device, the controller is configured to determine whether the second display is within a same room as the electronic device.

6. The electronic device of claim 1, wherein to project the selected viewable content to the selected second display, the controller is configured to perform one or more operations to cast to or mirror on the selected second display, the selected viewable content.

7. The electronic device of claim 1, wherein:
the projection module further enables projection of audible content from the electronic device to at least one audio output device associated with the second electronic device;
the acceptable range includes at least one of a viewable range and an audible range of a user of the electronic device; and
the selected viewable content includes video content and audio content.

8. The electronic device of claim 1, wherein the controller is configured to:
present a user interface showing identifier information of one or more second displays determined to be positioned within the acceptable range and in the line of sight of the electronic device to enable a user of the electronic device to select an appropriate at least one second electronic device to project the at least one selected viewable content to, for localized user consumption; and
responsive to receiving a selection of identifier information of the at least one second display, generate and issue a request for location information about the at least one second display, the location information comprising at least one of an absolute location, a relative location from the electronic device, and line of sight information relative to the electronic device.

9. A method comprising:
receiving, by an electronic device, a trigger to project selected viewable content to a selected second display of a second electronic device; and
in response to receiving the trigger to project selected viewable content to a selected second display:
evaluating location information of the electronic device and location information of the selected second display to determine whether the selected second display is located within an acceptable range of and in a line of sight relative to the electronic device; and
in response to confirming that the second electronic device is within the acceptable range and in the line-of-sight, initiating casting/mirroring of at least the selected viewable content from the electronic device to the second display for presentation on the second display.

10. The method of claim 9, further comprising:
in response to determining that the second display is not at least one of within the acceptable range or in the line-of-sight:
withholding casting/mirroring to the selected second display, pending confirmation by a user that the selected second display is an intended device to cast the selected viewable content;
generating a notification indicating that the second electronic device is not within at least one of the acceptable range or the line of sight of a user of the electronic device; and
rendering and presenting the notification within the display of the electronic device, the notification comprising selectable options for responding to the notification.

11. The method of claim 10, further comprising:
in response to receiving a first input to proceed with projecting the selected viewable content to the selected second display that is not within at least one of the acceptable range or the line of sight, initiating the casting/mirroring of the selected viewable content to the selected second display; and
in response to receiving a second input to not proceed with projecting the selected viewable content, withholding the casting/mirroring of the selected viewable content.

12. The method of claim 9, wherein determining whether the second electronic device is within the acceptable range of the electronic device comprises:
requesting the location information of the second display;
responsive to receiving the location information of the second display, determining a distance between the second display and the electronic device using current location information of the electronic device and the location information of the second electronic device; and
determining that the second display is within the acceptable range based on the distance between the second display and the electronic device being less than a range threshold.

13. The method of claim 9, wherein determining whether the second electronic device is within the line of sight of the electronic device comprises determining whether the second display is within a same room as the electronic device.

14. The method of claim 9, wherein projecting the at least one selected viewable content to the second display comprises performing one or more operations to cast to or mirror on the second display, the at least one selected viewable content.

15. The method of claim 9, wherein:
the acceptable range includes at least one of a viewable range and an audible range of a user of the electronic device; and
the selected viewable content includes video content and audio content.

16. The method of claim 9, further comprising:
presenting a user interface showing identifier information of one or more second displays determined to be positioned within the acceptable range and the line of sight of the electronic device to enable a user of the electronic device to select an appropriate at least one second electronic device to project the selected viewable content to, for localized user consumption; and
responsive to receiving a selection of identifier information of the at least one second display, generating and issuing a request for location information about the at least one second display, the location information comprising at least one of an absolute location, a relative location from the electronic device, and line of sight information relative to the electronic device.

17. A computer program product comprising:
a computer readable storage device; and
program code on the computer readable storage device that when executed by a processor associated with an electronic device enables the electronic device to provide functionality of:
receiving a trigger to project selected viewable content to a selected second display of a second electronic device; and
in response to receiving the trigger to project selected viewable content to a selected second display:
evaluating location information of the electronic device and location information of the selected second display to determine whether the selected second display is located within an acceptable range of and in a line of sight relative to the electronic device; and
in response to confirming that the second electronic device is within the acceptable range and in the line-of-sight, initiating casting/mirroring of at least the selected viewable content from the electronic device to the second display for presentation on the second display.

18. The computer program product of claim 17, further comprising:
in response to determining that the second display is not at least one of within the acceptable range or in the line-of-sight:
withholding casting/mirroring to the selected second display, pending confirmation by a user that the selected second display is an intended device to cast the selected viewable content;
generating a notification indicating that the second electronic device is not within at least one of the acceptable range or the line of sight of a user of the electronic device; and
rendering and presenting the notification within the display of the electronic device, the notification comprising selectable options for responding to the notification.

19. The computer program product of claim 18, further comprising:
in response to receiving a first input to proceed with projecting the selected viewable content to the selected second display that is not within at least one of the acceptable range or the line of sight, initiating the casting/mirroring of the selected viewable content to the selected second display; and
in response to receiving a second input to not proceed with projecting the selected viewable content, withholding the casting/mirroring of the selected viewable content.

20. The computer program product of claim 17, wherein determining whether the second electronic device is within the acceptable range of the electronic device comprises:
requesting the location information of the second display;
responsive to receiving the location information of the second display, determining a distance between the second display and the electronic device using current location information of the electronic device and the location information of the second electronic device; and
determining that the second display is within the acceptable range based on the distance between the second display and the electronic device being less than a range threshold.
